(19) United States
(12) Patent Application Publication
(10) Pub. No.: US 2023/0291055 A1
(43) Pub. Date: Sep. 14, 2023

(54) BATTERY MODULE

(71) Applicant: Robert Bosch GmbH, Stuttgart (DE)

(72) Inventor: Markus Schmitt, Tamm (DE)

(21) Appl. No.: 18/177,899

(22) Filed: Mar. 3, 2023

(30) Foreign Application Priority Data
Mar. 8, 2022 (DE) 10 2022 202 323.4

(51) Int. Cl. H01M 50/262; H01M 50/224; H01M 50/276

(52) U.S. Cl. CPC H01M 50/262; H01M 50/224; H01M 50/276

(57) ABSTRACT

A battery module has a housing element made of a metallic material and a cover element made of a metallic material, which elements are connected to one another by a plurality of screw connections such that, by forming a common interior configured to receive a plurality of battery cells, an electrical contact is made between the housing element and the cover element. The housing element or the cover element also forms a rib, and a direct mechanical contact is made between the rib of the housing element and the cover element or rib of the cover element and the housing element. A first sealing element is arranged between the housing element and the cover element such that the interior is fluidically sealed against the environment, with the plurality of screw connections and the rib being arranged outside of the first sealing element.

### BACKGROUND

The invention proceeds from a battery module.

A battery module comprises a plurality of individual battery cells, each comprising a positive voltage tap and a negative voltage tap, wherein the respective voltage taps are electrically connected to one another and thereby able to be connected to the battery module in an electrically conductive serial and/or parallel connection of the plurality of battery cells. In particular, the battery cells can each comprise a first voltage tap, in particular a positive voltage tap, and a second voltage tap, in particular a negative voltage tap, which are electrically conductively connected to one another by means of cell connectors, so that an electrically serial and/or parallel circuitry is formed.

In turn, battery modules are also interconnected into batteries or entire battery systems.

Belonging to the prior art are, e.g., DE 10 2019 220 034, DE 10 2019 210 790, DE 10 2019 103 049, or DE 10 2019 131 152.

By way of example, DE 10 2019 220 034 in this context describes a battery housing having a cover and a seal, which seals the battery interior against the environment in a water- and/or gas-tight manner. A filler agent is introduced into the gap adjacent the seal in order to protect against penetrating moisture, wherein the filler is of a permanently paste-like consistency.

DE 10 2019 210 790 discloses a battery housing with a circumferential sealing flange and a housing cover comprising a circumferential seal, which seals a contact edge formed between the components. A zero gap is formed on the outer side and radial to the seal, between the housing and the cover, wherein a fluidic seal is introduced into the zero gap.

DE 10 2019 103 049 describes a battery housing having a first housing part and a second housing part having an intermediate contact layer made of an electrically conductive and flexible material.

DE 10 2019 131 152 describes a battery housing with a receptacle body, a cover, and an intermediate sealing element. In this context, the cover comprises a deflector part for diverting environmental influences from the sealing gap.

### SUMMARY

A battery module provides the advantage that a reliable design for an electrically conductive connection between a housing element of the battery module and a cover element of the battery module can be made, while also providing reliable sealing of an interior of the battery module against the environment.

For this purpose, the present invention provides a battery module having a housing element, which is made of a metallic material, in particular aluminum, and having a cover element, which is made of a metallic material, in particular aluminum. The housing element and the cover element are in this case connected to one another by forming a common interior. This interior is designed to receive a plurality of battery cells. Preferably, a plurality of battery cells is received in the interior. Furthermore, the housing element and the cover element are connected to one another by a plurality of screw connections such that an electrical contact is made between the housing element and the cover element. An electromagnetically compatible connection between the housing element and the cover element is thereby made. Furthermore, the housing element or the cover element forms a rib, which is preferably formed circumferentially on the housing element or the cover element. A direct mechanical contact is made between the rib of the housing element and the cover element or between the rib of the cover element and the housing element. Furthermore, a first sealing element is arranged between the housing element and the cover element such that the interior is fluidically sealed against the environment. According to the invention, the plurality of screw connections and the rib are arranged outside of the first sealing element.

First, it should be noted at this point that an arrangement of the screw connections outside the first sealing element is in particular understood to mean that the screw connections do not pass through or contact the first sealing element, in particular the sealing material thereof, but rather are arranged at a distance from it. As a result, the screw connections are in particular not arranged in the area designed for sealing. The screw connections are thus arranged between the environment and the first sealing element. It can thereby be achieved that no sealing material is located at or within a screw connection, which could have an undefined influence on the formation of the screw connection and thus the screw parameters.

It should also be noted at this point that electrical contact between the housing element and the cover element is made by the screw connection, in particular because the screw connection mechanically and electrically contacts both the housing element and the cover element. In particular, the screw connections are made at defined locations and at a defined distance from one another. A connection exhibiting electromagnetic compatibility (abbreviated as EMC) can be made between the housing element and the cover element.

Sufficient surface compression can be provided by making the direct mechanical contact between the rib and the cover element or housing element. In particular, what is referred to as a hard stop is thereby formed between two metallic materials.

It should further be noted at this point that an arrangement of the rib outside of the first sealing element is in particular understood to mean that the rib does not pass through the first sealing element, in particular the sealing material thereof. In particular, it should also be understood that a contact surface of the rib, which is arranged to be in direct mechanical contact with the housing element or the cover element, is free of sealing material from the first sealing element. The rib can also be arranged to be in contact with the first sealing element and to represent a border for said first sealing element.

It is advantageous if a second sealing element is arranged on a side of the rib facing away from the first sealing element wherein the direct mechanical contact is in particular free of the first sealing element and the second sealing element. In other words, the rib is arranged between the first sealing element and the second sealing element. Doing so can prevent the direct mechanical contact between the rib and the cover element, or rather the housing element, from being influenced by sealing material from the first sealing element and/or the second sealing element. In particular, doing so could result in a gap or increase a technical zero gap, which would have an undefinable impact, e.g., on the plurality of screw connections.

In particular, a spatial separation between the first sealing element and the second sealing element can also be provided as a result. As a result, different materials can, e.g., be used for the first sealing element and the second sealing element because the rib preferably represents a separating element and, e.g., prevents mutual contact between the first sealing element and the second sealing element. It should at this point be noted that the first sealing element can form what is referred to as a main seal, and the second sealing element can form what is referred to as a presealing means. Even if the second sealing element fails as a presealing means, reliable sealing of the interior against the environment, electromagnetic shielding of the interior, and an electromagnetically compatible connection between the cover element and the housing element can in particular also be achieved by the first sealing element acting as the main seal.

Further, it is advantageous if a first sealing direction of the first sealing element and a second sealing direction of the second sealing element are arranged substantially perpendicular to one another. As a result, it is possible that the second sealing element can during production be simply pushed out of a resulting gap, thus enabling this gap to be “over-filled”. Doing so can even more efficiently prevent condensation from penetrating and corrosive infiltration thereby. At this point, it should be noted that a respective sealing direction is arranged parallel to the two sealing surfaces which are arranged opposite one another and intended to be sealed.

According to a preferred aspect of the invention, a support surface of the rib is designed to be elevated over a first sealing surface of the housing element or a second sealing surface of the cover element. In particular, a distance between the first sealing surface of the housing element and the second sealing surface of the cover element can be adjustable as a result. The height of the first sealing element can in particular be adjusted as a result.

It is advantageous if individual screw connections are arranged at a distance from one another, and/or a first sealing surface of the housing element as well as a second sealing surface of the cover element are arranged at a distance from one another such that electromagnetic shielding of the interior against the environment is provided. It should be noted at this point that a certain distance between the individual screw connections must be maintained, and a certain distance between the first sealing surface and the second sealing surface must also be maintained, in order to provide electromagnetic shielding of the interior of the battery module against the environment. In particular, the direct mechanical contact between the rib and the cover element, or rather the housing element, can be advantageous in this respect.

It is advantageous if the screw connections in each case comprise a screw receiving means, in which a screw means is received in each case. The housing element or the cover element thereby forms a respective screw receiving means. Furthermore, a support surface of the screw receiving means is directly connected to a first contact surface of the housing element, or rather a second contact surface of the cover element. As a result, sufficient surface compression can be formed between the housing element and the cover element so that a penetration of condensate into the formed sealing gap can be avoided. In particular, a hard stop can advantageously also be formed between, for example, the cover element and a head of a screw means. In particular, what is referred to as a hard screw joint with metallic contact surfaces is thus formed.

Particularly preferably, the screw receiving means are each designed as screw bosses. The screw bosses can in particular be geometrically designed such that their contact surfaces present a minimal risk of corrosion. Furthermore, the screw bosses can be designed such that, e.g., potential voltage spikes that can occur during sealing bonding are minimized or avoided. The contour towards the sealing surface is preferably designed as a continuous linear drawing in order to minimize stress concentrations of the sealing bonding in the area of the screw bosses.

A support surface of a screw receiving means, in particular a screw boss, is advantageously designed to be elevated over a first sealing surface of the housing element or a second sealing surface of the cover element. In particular, a distance between the first sealing surface of the housing element and the second sealing surface of the cover element can thus be adjustable. In other words, the distance between the housing element and the cover element can be adjusted by way of the individual support surfaces. On the one hand, the height of the sealing element can be adjusted to a certain extent and, on the other hand, the distance between the sealing surface and the screw boss can be adjusted to the degree permitted for the electromagnetic shielding. The height of this gap thereby determines the distance between the individual screw connections.

Such an elevation additionally offers the advantage that the sealing surface is not contaminated on the assembly line because the screw receiving means, or rather the screw bosses, can be used as support surfaces. This is particularly advantageous for structural adhesives for such a secure sealing bonding.

It should further be noted at this point that the elevation of the support surface of a screw receiving means over the first sealing surface of the housing element or the second sealing surface of the cover element and the elevation of the rib over the first sealing surface of the housing element or the second sealing surface of the cover element are preferably designed to have an identical height.

Preferably, the housing element is designed as a die cast aluminum housing.

Furthermore, preferably, the cover element is designed as a deep-drawn part made of an aluminum alloy.

Furthermore, it is preferable if the first sealing element and/or the second sealing element are each designed as an adhesive. In particular, a structural adhesive is preferred.

At this point, it should also be noted that positioning of the cover element until hardening of the adhesive can be ensured via the screw connection. Preferably, during assembly, the adhesive is applied to the first sealing surface of the housing element.

In order to produce a battery module, a defined amount of the material from the first sealing element is applied to the sealing geometry, in particular prior to the formation of the screw connection, so that the distance between the housing element and the cover element is completely filled and any potential corrosive infiltration of the seal is minimized.

### BRIEF DESCRIPTION OF THE DRAWINGS

Embodiment examples of the invention are illustrated in the drawings and explained in greater detail in the following description.

Shown are:

FIG. 1 a detail of a battery module according to the invention in a perspective view,

FIG. 2 in a sectional view, a screw connection of a battery module according to the invention, and

FIG. 3 in a sectional view, a connection between the rib of the housing element and the cover element.

### DETAILED DESCRIPTION

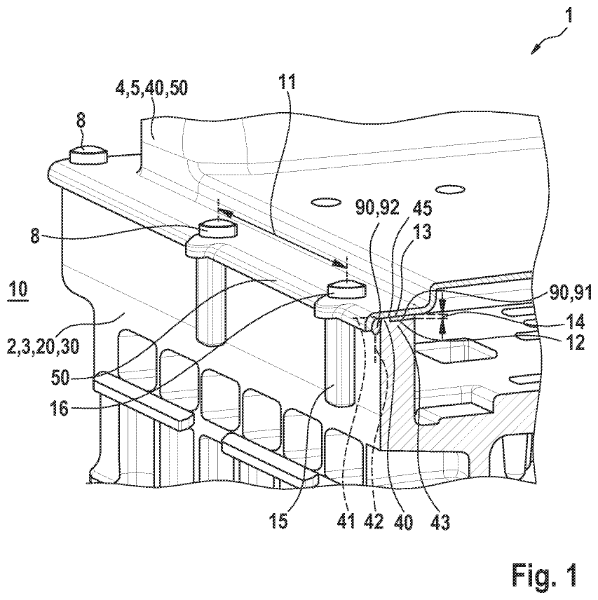

FIG. 1 shows a section of a battery module 1 according to the invention in a perspective view.

The battery module 1 in this case comprises a housing element 2, which is formed from a metallic material 3, in particular aluminum 30. The housing element 2 is in particular designed as a die cast aluminum housing 20.

The battery module 1 in this case comprises a cover element 4, which is made of a metallic material 5, in particular aluminum 50. The cover element 4 is in particular designed as a deep-drawn part 40 made of an aluminum alloy.

The housing element 2 and the cover element 4 are in this case connected to one another by forming a common interior 6, which cannot be seen in FIG. 1 and is designed to receive a plurality of battery cells 7. In this case, the plurality of battery cells 7 which are received in the interior 6 are also not discernible in FIG. 1.

The housing element 2 and the cover element 4 are in this case connected to one another by a plurality of screw connections 8. The connection is in this case designed such that an electrical contact is made between the housing element 2 and the cover element 4. The screw connections 8 here in each case comprise a screw receiving means 15, in which in each case a screw means 16 is received.

In this case, the housing element 2 or the cover element 4 can, e.g., form the respective screw receiving means 15. In the embodiment example shown in FIG. 1, for example, the housing element 2 forms the respective screw means receptacles 15.

Furthermore, individual screw connections 8 are arranged at a distance from one another in such that electromagnetic shielding of the interior 6 against the environment 10 is provided. In particular, a distance 11 between two screw connections 8 is selected such that electromagnetic shielding of the interior 6 against the environment 10 is ensured.

The housing element 2 further forms a rib 40 circumferentially on the housing element 2. A direct mechanical contact 45 is made between the rib 40 of the housing element 2 and the cover element 4.

Furthermore, a first sealing element 91 is arranged between the housing element 2 and the cover element 4. The first sealing element 91 is in this case arranged such that the interior 6 is fluidically sealed against the environment 10. Further, a second sealing element 92 is arranged on a side 50 of the rib 40 facing away from the first sealing element 91. The direct mechanical contact 45, as can be seen from FIG. 1, is in this case free of the first sealing element 91 and the second sealing element 92. The first sealing element 91 and the second sealing element 92 are particularly designed as adhesive 90. Preferably, a structural adhesive is provided.

Furthermore, it can be seen in FIG. 1 that a first sealing direction 41 of the first sealing element 91 and a second sealing direction 42 of the second sealing element 92 are arranged to be substantially perpendicular to one another.

FIG. 1 also shows that a support surface 43 of the rib 40 is designed to be elevated over a first sealing surface 12 of the housing element 2 such that a distance 14 is adjustable between the first sealing surface 12 of the housing element 2 and the second sealing surface 13 of the cover element 4.

Furthermore, a first sealing surface 12 of the housing element 2 as well as a second sealing surface 13 of the cover element 4 are arranged at a distance from one another such that electromagnetic shielding of the interior 6 against the environment 10 is provided. In particular, a distance 14 between the first sealing surface 12 and the second sealing surface 13 is selected so as to ensure electromagnetic shielding of the interior 6 from the environment 10. The direct mechanical contact between the rib 40 of the housing element 2 and the cover element 4 can be advantageous in this respect.

The plurality of screw connections 8 and the rib 40 are in this case arranged outside of the first sealing element 9.

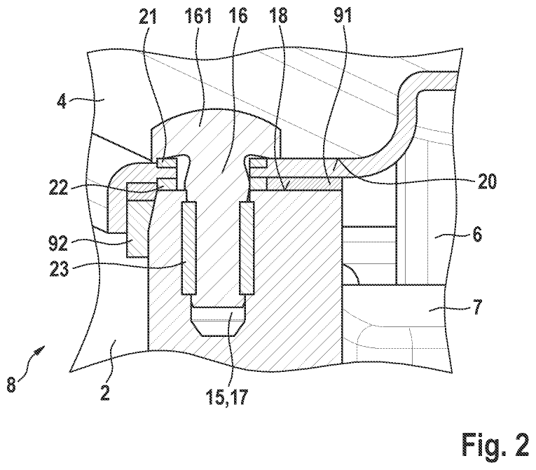

FIG. 2 shows a screw connection 8 in a sectional view. In particular, a sectional view through the screw connection 8 between the housing element 2 and the cover element 4 is shown.

The housing element 2 and the cover element 4 are initially apparent in this case. Further, the first sealing element 91 and the second sealing element 92 can also be seen.

The interior 6 and the plurality of battery cells 7 can also be seen.

The screw connection 8 in this case comprises a screw receiving means 15, which is in particular designed as a screw boss 17, and in which a screw means 16 is received.

A first direct contact 21, in particular a metallic contact, is thus made between a head 161 of the screw means 16 and the cover element 4.

Furthermore, a second direct contact 22, in particular a metallic contact, is thereby made between the cover element 4 and the screw receiving means 15 of the housing element 2, or rather the screw boss 17 of the housing element 2.

Further, a third direct contact 23, in particular a metallic contact, is thereby made between the screw receiving means 15 of the housing element 2, or rather the screw boss 17 of the housing element 2, and the screw means 16.

Via the first direct contact 21, the second direct contact 22, and the third direct contact 23, an electrical contact can generally be made in an electromagnetically compatible connection between the housing element 2 and the cover element 4.

In particular, a hard screw joint is thereby formed by the metallic contacts. No material from the first sealing element 91 and/or the second sealing element 92 is in this case arranged in the screw region, which could lead to interference of the EMC connection or to the insertion of the screw connection 8.

The design of the support surface 18 of the screw bosses 17 is preferably geometrically designed such that no stress spikes are created for the sealing bonding. The contour for the sealing surface is designed in a continuous linear manner in order to minimize stress concentrations of the sealing bonding in the area of the screw bosses 17. The outer contour of the screw bosses 17 is in this case geometrically designed such that the width of the permitted gap in combination with the height of the permitted gap meets the EMC requirements.

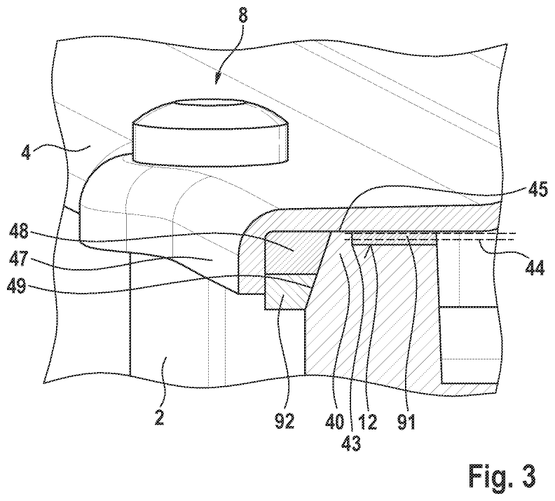

FIG. 3 shows a sectional view of a connection between the rib 40 of the housing element 2 and the cover element 4.

A screw connection 8 can also be seen in this case.

Further, the first sealing element 91 as well as the second sealing element 92 can be seen.

The direct mechanical contact 45 is in this case made between the rib 40 of the housing element 2 and the cover element 4. In particular, it can be seen that the direct mechanical contact 45 is free of the first sealing element 91 and the second sealing element 92. A technical zero gap 44 is thereby formed between the rib 40 and the housing element 4. In particular, this technical zero gap 44 is also crucial for the electromagnetic shielding of the interior 6 against the environment 10.

In this case, a “hard stop” is again formed between the rib 40 of the housing element 2 and the cover element 4 between two metallic materials. Furthermore, the support surface 43 of the rib 40 is designed to be elevated over a first sealing surface 12 of the housing element 2.

Further, it can be seen that the housing element 2 and/or the rib 40 in the area of the second sealing element 92 form a bevel 49, on which the second sealing element 92 rests.

Furthermore, a compensation volume 48 is formed, which is in particular free of material from the second sealing element 92 at the beginning of manufacture of the battery module 1, so that said sealing element can at least be partially pushed into the compensation volume 48 during manufacture. Material from the second sealing element 92 can also be displaced in the opposite direction. An overfilling of the gap can thereby be formed. In particular, corrosive infiltration and capillary effects can be thereby avoided.

The cover element 4 further comprises a rounding 47, which serves to border and retain the second sealing element 92.

1. A battery module comprising:
a housing element (2) made of a metallic material (3) and a cover element (4) made of a metallic material (5), which elements are connected to one another by a plurality of screw connections (8), such that, by forming a common interior (6), configured to receive a plurality of battery cells (7), an electrical contact is made between the housing element (2) and the cover element (4), wherein the housing element (2) or the cover element (4) also forms a rib (40) and a direct mechanical contact (45) is made between the rib (40) of the housing element (2) and the cover element (4) or between the rib (40) of the cover element (4) and the housing element (2), and a first sealing element (91) is also arranged between the housing element (2) and the cover element (4) such that the interior (6) is fluidically sealed from the environment (10),
wherein the plurality of screw connections (8) and the rib (40) are arranged outside of the first sealing element (91).

2. The battery module according to claim 1, wherein a second sealing element (92) is arranged on a side (50) of the rib (40) facing away from the first sealing element (91), wherein said direct mechanical contact (45) is free of the first sealing element (91) and the second sealing element (92).

3. The battery module according to claim 2, wherein a first sealing direction (41) of the first sealing element (91) and a second sealing direction (42) of the second sealing element (92) are substantially perpendicular to one another.

4. The battery module according to claim 1, wherein a support surface (43) of the rib (40) is elevated over a first sealing surface (12) of the housing element (2) or over a second sealing surface (13) of the cover element (4) such that a distance (14) between the first sealing surface (12) of the housing element (2) and the second sealing surface (13) of the cover element (4) is adjustable.

5. The battery module according to claim 1, wherein individual screw connections (8) are arranged at a distance from one another, and/or a first sealing surface (12) of the housing element (2) as well as a second sealing surface (13) of the cover element (4) are arranged at a distance from one another, such that electromagnetic shielding of the interior (6) against the environment (10) is provided.

6. The battery module according to claim 1, wherein the screw connections (8) each comprise a screw receiving means (15), in which a sliding means (16) is respectively received, wherein the housing element (2) or the cover element (4) forms a respective screw receiving means (15), and a support surface (18) of the screw receiving means (15) is directly connected with a first contact surface (19) of the housing element (2), or with a second contact surface (20) of the cover element (4).

7. The battery module according to claim 6, wherein the screw receiving means (15) are screw bosses (17).

8. The battery module according to claim 6, wherein a support surface (18) of a screw receiving means (15) is configured to be elevated over a first sealing surface (12) of the housing element (2) or a second sealing surface (13) of the cover element (4) such that, a distance (14) between the first sealing surface (12) of the housing element (2) and the second sealing surface (13) of the cover element (4) is adjustable.

9. The battery module according to claim 1, wherein the housing element (2) is configured as a die cast aluminum housing (20), and/or the cover element (4) is designed as a deep-drawn part (40) made of an aluminum alloy.

10. The battery module according to claim 1, wherein the first sealing element (91) and/or the second sealing element (92) are each designed as an adhesive (90).

11. The battery module according to claim 1, wherein the housing element (2) is made of aluminum (30).

12. The battery module according to claim 1, wherein the cover element (4) is made of aluminum (50).

13. The battery module according to claim 1, wherein the rib (40) is circumferential.

14. The battery module according to claim 8, wherein the support surface (18) of the screw receiving means (15) is a screw boss (17).
